(19) United States
(12) Patent Application Publication
(10) Pub. No.: US 2025/0229554 A1
(43) Pub. Date: Jul. 17, 2025

(54) LIQUID DISCHARGE APPARATUS, IMAGE FORMING APPARATUS, AND LIQUID DISCHARGE HEAD UNIT ADJUSTMENT METHOD

(71) Applicants: Junichi TERAI, Kanagawa (JP); Makoto KOBAYASHI, Kanagawa (JP)

(72) Inventors: Junichi TERAI, Kanagawa (JP); Makoto KOBAYASHI, Kanagawa (JP)

(21) Appl. No.: 19/011,646

(22) Filed: Jan. 7, 2025

(30) Foreign Application Priority Data
Jan. 11, 2024 (JP) 2024-002832
Sep. 6, 2024 (JP) 2024-154086

(51) Int. Cl. B41J 25/308; B41J 2/21; B41J 15/04; B41J 29/00

(52) U.S. Cl. CPC B41J 25/308; B41J 2/2103; B41J 15/046; B41J 29/00

(57) ABSTRACT

A liquid discharge apparatus includes a head having a nozzle surface having nozzles to discharge a liquid onto a medium in a discharge direction; a conveyor to convey the medium to the head along a conveyance surface in a conveyance direction, the conveyor including a pair of conveyance guides on an upstream side and a downstream side of the head in the conveyance direction; a support between the pair of conveyance guides in the conveyance direction, the support supportable a distance detector at a position facing the head in the discharge direction, and the distance detector to detect a first distance and a second distance; and a lifter to move the head in the discharge direction according to the first distance from the distance detector to the conveyance surface of the conveyor; and the second distance from the distance detector to the nozzle surface of the head.

### CROSS-REFERENCE TO RELATED APPLICATIONS

This patent application is based on and claims priority pursuant to 35 U.S.C. § 119 (a) to Japanese Patent Application No. 2024-002832, filed on Jan. 11, 2024, in the Japan Patent Office, and Japanese Patent Application No. 2024-154086, filed on Sep. 6, 2024, in the Japan Patent Office, the entire disclosure of each is hereby incorporated by reference herein.

### BACKGROUND

### Technical Field

The present embodiments relate to a liquid discharge apparatus, an image forming apparatus, and a liquid discharge head unit adjustment method.

### Related Art

A liquid discharge apparatus includes a head unit that discharges liquid onto a recording medium. An image forming apparatus forms an image with liquid discharged from a head unit onto a recording medium.

A printing apparatus includes a detection unit that detects a height of floating of a recording medium and a lifter that lifts and lowers a print head according to the height of floating detected by the detection unit, for the purpose of preventing deterioration in image quality due to floating of the recording medium and breakage of a head unit.

### SUMMARY

According to an embodiment of the present disclosure, a liquid discharge apparatus is provided that includes a head having a nozzle surface having nozzles to discharge a liquid onto a medium in a discharge direction; a conveyor to convey the medium to the head along a conveyance surface in a conveyance direction, the conveyor including a pair of conveyance guides on an upstream side and a downstream side of the head in the conveyance direction; a support between the pair of conveyance guides in the conveyance direction, the support supportable a distance detector at a position facing the head in the discharge direction, and the distance detector to detect a first distance and a second distance; and a lifter to move the head in the discharge direction according to the first distance from the distance detector to the conveyance surface of the conveyor; and the second distance from the distance detector to the nozzle surface of the head.

### BRIEF DESCRIPTIONS OF DRAWINGS

A more complete appreciation of embodiments of the present disclosure and many of the attendant advantages and features thereof can be readily obtained and understood from the following detailed description with reference to the accompanying drawings, wherein:

FIG. 1 is an external view illustrating a general arrangement of an embodiment of a liquid discharge apparatus;

FIG. 2 is a diagram illustrating a configuration example of a control system of the liquid discharge apparatus;

FIG. 3 is a diagram illustrating a configuration example of an image former included in the liquid discharge apparatus;

FIG. 4 is a perspective view illustrating a first example of a head unit;

FIG. 5 is a configuration diagram of a conveyance device;

FIG. 6 is a diagram describing a liquid discharge position and the like;

FIG. 7 is a diagram describing a liquid discharge head unit adjustment method;

FIG. 8 is a diagram describing the liquid discharge head unit adjustment method;

FIG. 9 is a perspective view illustrating the head unit;

FIG. 10 is a perspective view illustrating a support portion for a laser displacement meter;

FIG. 11 is a perspective view illustrating a mounting structure of the laser displacement meter; and

FIG. 12 is a flowchart illustrating a flow chart of the liquid discharge head unit adjustment method.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of the present embodiments will be described with reference to the drawings. In the drawings, the same components are denoted by the same reference signs, and redundant description may be omitted.

### Embodiment of Image Forming Apparatus

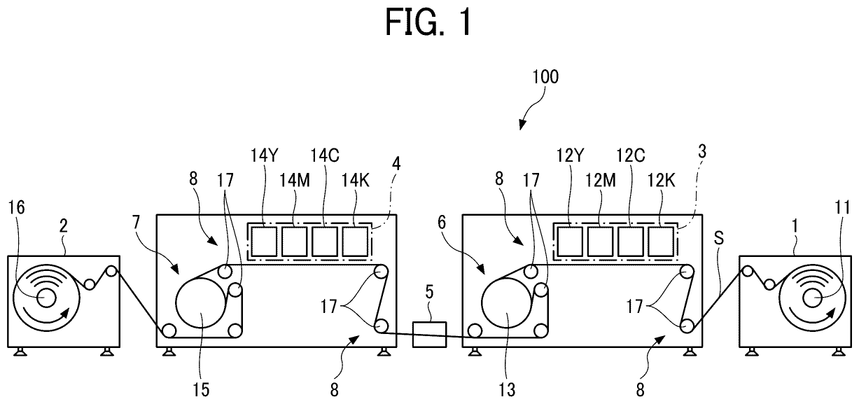

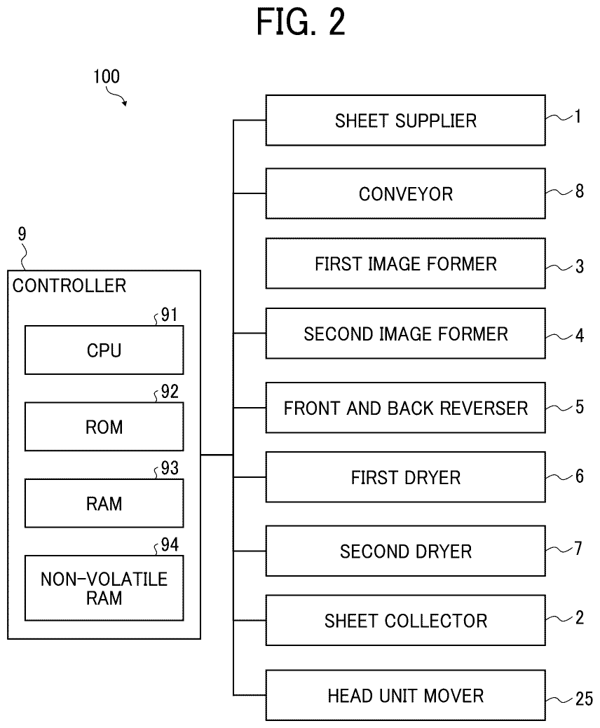

First, on the basis of FIGS. 1 and 2, a description will be given of a configuration of an inkjet image forming apparatus that is an embodiment of a liquid discharge apparatus according to an embodiment of the present disclosure. FIG. 1 is a diagram illustrating a general arrangement of the inkjet image forming apparatus. FIG. 2 is a diagram illustrating a control system of the inkjet image forming apparatus.

As illustrated in FIG. 1, an image forming apparatus 100 according to an embodiment of the present disclosure includes: a sheet supplier 1 that supplies a sheet S as a conveyance object that is a recording medium for image formation; a conveyor 8 that conveys the sheet S supplied; a first image former 3 that forms an image on a front side surface of the sheet S; a second image former 4 that forms an image on a back side surface of the sheet S; a front and back reverser 5 that reverses the front and back of the sheet S; a first dryer 6 and a second dryer 7 that dry the sheet S; and a sheet collector 2 that collects the sheet S on which an image is formed.

In addition, the image forming apparatus 100 according to an embodiment of the present disclosure includes a controller 9 (see FIG. 2) for controlling the sheet supplier 1, the conveyor 8, the first image former 3, the second image former 4, the front and back reverser 5, the first dryer 6, the second dryer 7, the sheet collector 2, and a head unit mover 25. The head unit mover 25 illustrated in FIG. 2 is omitted in FIG. 1.

The sheet supplier 1 includes a supply roller 11 in which the sheet S having a long length is wound in a roll shape. The supply roller 11 is enabled to rotate in an arrow direction illustrated in FIG. 1, and the sheet S is fed out by rotation of the supply roller 11.

The conveyor 8 includes a conveyance device including multiple conveyance rollers 17. The sheet S is stretched around each conveyance roller 17, and the sheet S is conveyed by rotation of each conveyance roller 17. The conveyance roller 17 also includes a pipe, a shaft, and the like having a circular cross section.

The first image former 3 includes multiple head units 12K, 12C, 12M, and 12Y that discharges liquid ink onto the sheet S. Each of the head units 12K, 12C, 12M, and 12Y discharges ink onto the front side surface of the sheet S on the basis of image data formed on the front side surface of the sheet S among image data generated by the controller 9 to form an image on the sheet S. Here, the ink is a liquid containing a coloring material, a solvent, and crystalline resin particles dispersed in the solvent. The crystalline resin is a resin that undergoes a phase change when heated to a predetermined melting point or higher and melts into a liquid from a crystalline state.

The first dryer 6 includes a heating drum 13 that heats the sheet S to promote drying of the ink on the sheet S. The heating drum 13 is a cylindrical member that rotates while the sheet S is wound around the outer peripheral surface, and a heating source such as a halogen heater is disposed inside. The heating drum 13 is disposed below a conveyance path on which the sheet S is conveyed (back side of the sheet S). For this reason, when the sheet S is conveyed from the first image former 3, the lower surface (back side surface) of the sheet S comes into contact with the outer peripheral surface of the heating drum 13, and the sheet S is conveyed while being heated by the heating drum 13 rotating. As a result, drying of the ink on the sheet S is promoted. A rotation speed of the heating drum 13 at this time is controlled by the controller 9 to be substantially the same as a conveyance speed in the sheet supplier 1, the sheet collector 2, the conveyor 8, and the like. The sheet S is therefore conveyed without being shifted in a sheet conveyance direction with respect to the outer peripheral surface of the heating drum 13.

The front and back reverser 5 includes a device that reverses the positions of the front side and the back side of the sheet S. When passing through the front and back reverser 5, the sheet S conveyed from the first dryer 6 is reversed and sent to the second image former 4. That is, when the sheet S is conveyed in a state where the front side surface of the sheet S faces upward, the sheet S is reversed to be in a state where the front side surface of the sheet S faces downward (the back side surface of the sheet S faces upward) to be conveyed by the front and back reverser 5.

The second image former 4 basically has the same configuration as the first image former 3, and includes multiple head units 14K, 14C, 14M, and 14Y that discharges liquid ink onto the sheet S. However, in the second image former 4, an image is formed on the back side surface of the sheet S. That is, since the sheet S is conveyed, to the second image former 4, in a state of being reversed by the front and back reverser 5, the second image former 4 discharges ink to the back side surface of the sheet S on the basis of image data formed on the back side surface of the sheet S among image data generated by the controller 9 to form an image on the sheet S.

Similarly to the first dryer 6, the second dryer 7 includes a heating drum 15 that heats the sheet S. As illustrated in FIG. 1, the heating drum 15 of the second dryer 7 is disposed below the conveyance path similarly to the heating drum 13 of the first dryer 6, but the sheet S conveyed is reversed from front to back, and thus comes into contact with the front side surface of the sheet S. At this time, even if an image is formed on the front side surface of the sheet S, since the drying of the ink has already been promoted by the first dryer 6, the image is not disturbed by the heating drum 15 coming in contact with the image on the front side.

The sheet collector 2 includes a collection roller 16 that winds and collects the sheet S. The collection roller 16 is enabled to rotate in an arrow direction illustrated in FIG. 1, and when the collection roller 16 rotates, the sheet S is wound into a roll shape and collected. The sheet collector 2 may include a post-processor that performs post-processing of cutting the sheet S to a predetermined length or aligning the sheet S cut.

The controller 9 illustrated in FIG. 2 includes an information processing device such as a personal computer (PC). The controller 9 generates image data to be formed on the front side surface and the back side surface of the sheet S, and controls various operations of the sheet supplier 1, the conveyor 8, the first image former 3, the second image former 4, the front and back reverser 5, the first dryer 6, the second dryer 7, the sheet collector 2, and the head unit mover 25. For example, the controller 9 controls rotation speeds of the supply roller 11, the collection roller 16, and each conveyance roller 17, and temperatures of heating sources for heating the heating drums 13 and 15.

The controller 9 includes a central processing unit (CPU) 91, a read only memory (ROM) 92, a random access memory (RAM) 93, a non-volatile random access memory (NVRAM) 94, and the like.

The CPU 91 is an arithmetic unit, and controls entire operation of the image forming apparatus 100. The ROM 92 is a read-only non-volatile storage medium and stores programs such as firmware.

The RAM 93 is a volatile storage medium that enables reading and writing information at high speed, and is used as a work area when the CPU 91 processes information. The NVRAM 94 is a non-volatile storage medium that enables reading and writing information, and stores setting values necessary for controlling each part of the image forming apparatus 100. The setting values stored in the NVRAM 94 are, for example, an adjustment value of a height position of a head unit 12 according to a type (sheet thickness) of the sheet S, and the like.

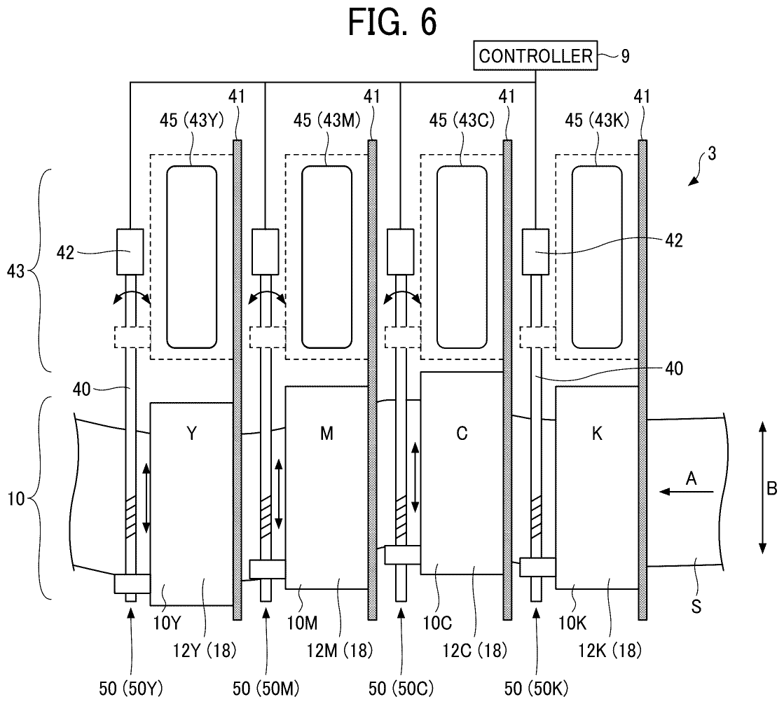

The head unit mover 25 includes a motor 42 for moving the head unit 12 between a liquid discharge position 10 and a cleaning position 43, and the motor 42 is provided corresponding to each of head units 12 (see FIG. 6). The head units 12 can independently move the head units 12K, 12C, 12M, and 12Y by driving corresponding motors 42, respectively, between the liquid discharge position 10 and the cleaning position 43 (see FIG. 6).

### Configuration of Image Former

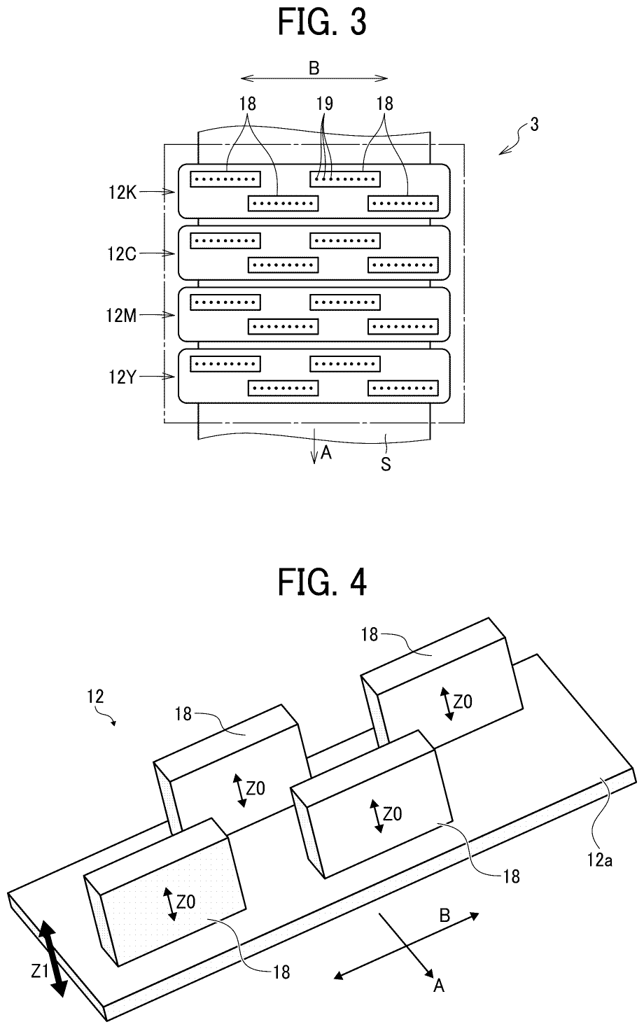

Next, a configuration of an image former according to an embodiment of the present disclosure will be described in detail on the basis of FIG. 3. As described above, the image former in the present embodiment includes the first image former 3 and the second image former 4. Since configurations thereof are basically the same as each other, only the configuration of the first image former 3 will be described, and the description of the configuration of the second image former 4 will be omitted.

As illustrated in FIG. 3, in the first image former 3 according to an embodiment of the present disclosure, four head units 12K, 12C, 12M, and 12Y that discharge black (K), cyan (C), magenta (M), and yellow (Y) inks are disposed in order from the upstream side in a conveyance direction A in which the sheet S is conveyed. The order of the head units 12K, 12C, 12M, and 12Y of the respective colors may be an order other than the illustrated order. In addition, the color of the ink to be used may be a color other than black, cyan, magenta, and yellow. The number of head units may be other than four.

Each of the head units 12K, 12C, 12M, and 12Y is a head unit of a line head system longer than a dimension in the width direction of the sheet S and including the four liquid discharge heads 18. Each liquid discharge head 18, which is a liquid discharger, has multiple nozzles 19, and discharges ink (liquid) from each nozzle 19 to the sheet S. In addition, the liquid discharge heads 18 are alternately disposed over the entire width direction of an image forming area on the sheet S, and when the sheet S is conveyed to positions facing the head units 12K 12C, 12M, and 12Y, ink is discharged from the liquid discharge heads 18, and an image is formed on the sheet S. The number of liquid discharge heads may be other than four. The liquid discharge head 18 may be referred to simply as a “head”. Further, the head units 12K, 12C, 12M, and 12Y may be referred to simply as a “head”. Each of the head units 12K, 12C, 12M, and 12Y includes the liquid discharge head 18 having a nozzle surface having nozzles 19 to discharge a liquid onto a sheet S (medium) in a discharge direction.

The “width direction” of the sheet S is a direction parallel to a conveyance surface on which the sheet S is conveyed and orthogonal to the conveyance direction A. That is, the “width direction” of the sheet S means a direction indicated by an arrow “B” in FIG. 3. The above “conveyance surface” is a surface through which the sheet S to be conveyed passes, and includes, for example, a virtual surface connecting together contact portions with the sheet S of multiple conveyance rollers conveying the sheet S, a sheet placing surface of a conveyance belt on which the sheet S is placed and conveyed, or the like. The “sheet width direction” in the following description has the same meaning.

### First Example of Head Unit

Next, the head unit 12 will be further described. FIG. 4 is a diagram describing a perspective configuration of the head unit 12. As illustrated in FIG. 4, the head unit 12 includes four liquid discharge heads 18 and a base member 12a for supporting the four liquid discharge heads 18. Each of the liquid discharge heads 18 includes a lifter Z0 as an independent lifter. The lifter Z0 may be referred also as a “lifting and lowering mechanism Z0”.

A manual mechanism such as a feed screw or an eccentric pin is generally employed as the lifter Z0. Note that an electric mechanism such as a servomotor or an actuator may be employed as the lifter Z0.

At the time of assembling the image forming apparatus 100, the lifter Z0 is temporarily secured at an appropriate position. Thereafter, an adjustment by the lifter Z0 is performed. A method for the adjustment corresponds to the gist of the present embodiment and will be described in detail later.

The head unit 12 also includes a lifter Z1 as a lifter that lifts and lowers the entire head unit 12. By including the lifter Z1, the head unit 12 can keep a gap between a nozzle surface and the sheet S constant by lifting and lowering even in a case where the thickness of the sheet S differs. Note that each liquid discharge head 18 also includes independent fine adjustment mechanisms in an A direction, a B direction, and a rotation direction.

### Configuration Example of Conveyor

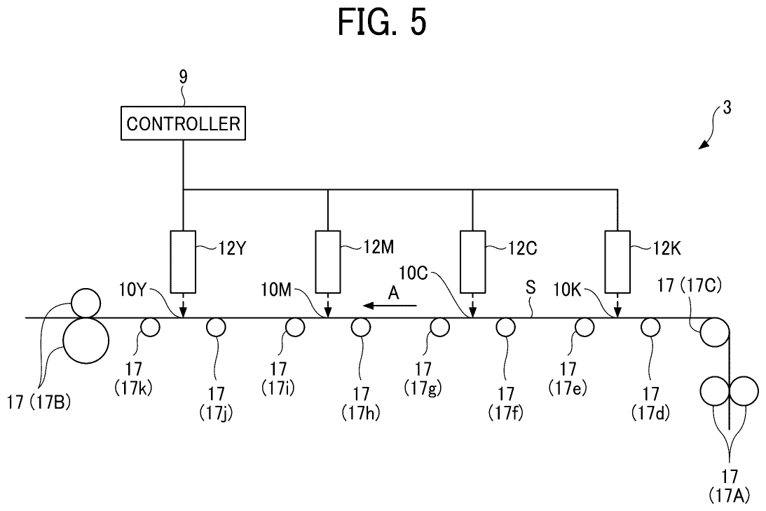

Subsequently, on the basis of FIG. 5, a description will be given of a configuration of a conveyance device 20 (conveyor 8) disposed in the first image former 3.

As illustrated in FIG. 5, the conveyance device 20 (conveyor 8) includes the conveyance rollers 17 as conveyance guides. Among the conveyance rollers 17 illustrated in FIG. 5, driving rollers 17A and 17B on the upstream side and the downstream side (the most upstream and the most downstream in FIG. 5) in the conveyance direction A of the sheet S are two pairs of driving rollers that convey the sheet S while sandwiching the sheet S from the front side and the back side. In addition to these driving rollers 17A and 17B, the sheet S is conveyed by a driving roller 17C (conveyance roller not paired) disposed on the downstream side of and next to the driving roller 17A on the upstream side.

Between the driving roller 17C on the upstream side and the driving roller 17B on the downstream side, multiple driven rollers 17d to 17k as the conveyance rollers 17 is disposed. Instead of the driven rollers 17d to 17k, multiple driving rollers may be disposed. The driven rollers 17d to 17k are disposed on the upstream side and the downstream side with respective liquid discharge positions 10K, 10C, 10M, and 10Y of the head units 12K, 12C, 12M, and 12Y interposed therebetween. As described above, since the driven rollers 17d to 17k are disposed on the upstream side and the downstream side with the respective liquid discharge positions 10K, 10C, 10M, and 10Y interposed therebetween, flutter of the sheet S particularly at the liquid discharge positions 10K, 10C, 10M, and 10Y is suppressed, and the sheet S can be stably conveyed.

Note that if the heights of the liquid discharge heads 18 included in the head units 12K, 12C, 12M, and 12Y are different from each other, landing positions are shifted, density unevenness occurs within the same color, and color shift occurs between multiple colors, and thus, it is necessary to accurately perform assembly and adjustment, and details will be described later since this is the essence of the embodiment.

### Position Changing Mechanism of Head Unit

Subsequently, on the basis of FIG. 6, a description will be given of a position changing mechanism of the head unit 12. As illustrated in FIG. 6, the head unit 12 is movable so as to be located at either the liquid discharge position 10 or the cleaning position 43.

### Cleaning Position

First, referring to FIG. 6, a description will be given of the cleaning position 43. The cleaning position 43 is an example of a second position. The cleaning position 43 may be a position of a head unit during execution of cleaning operation. The cleaning position 43 may be, for example, a position above a discharge receiver that is a cleaning portion 45. For example, in a case where the cleaning operation is wiping operation, a position of a head unit during execution of the wiping operation may be used.

The cleaning position 43 includes cleaning positions 43K, 43C, 43M, and 43Y.

The cleaning position 43K is a position of the head unit 12K during execution of cleaning. The cleaning position 43C is a position of the head unit 12C during execution of cleaning. The cleaning position 43M is a position of the head unit 12M during execution of cleaning. The cleaning position 43Y is a position of the head unit 12Y during execution of cleaning. The cleaning positions 43K, 43C, 43M, and 43Y are positions deviating from the liquid discharge position 10 in the width direction B of the sheet S. The cleaning positions 43K, 43C, 43M, and 43Y are separated from the liquid discharge position 10 in the width direction B. The liquid discharge position 10 includes the liquid discharge positions 10K, 10C, 10M, and 10Y.

The cleaning positions 43K, 43C, 43M, and 43Y are positions not overlapping the sheet S. In the conveyance direction A of the sheet S, the cleaning positions 43K, 43C, 43M, and 43Y are disposed at predetermined intervals corresponding to the head units 12K 12C, 12M, and 12Y.

### Position Changing Mechanism

The image forming apparatus 100 includes a position changing mechanism 50 that moves the head units 12K, 12C, 12M, and 12Y between the cleaning positions 43K, 43C, 43M, and 43Y and the liquid discharge positions 10K, 10C, 10M, and 10Y in the width direction B. The position changing mechanism 50 includes position changing mechanisms 50K, 50C, 50M, and 50Y. The position changing mechanism 50K moves the head unit 12K in the width direction B. The position changing mechanism 50C moves the head unit 12C in the width direction B. The position changing mechanism 50M moves the head unit 12M in the width direction B. The position changing mechanism 50Y moves the head unit 12Y in the width direction B.

In a case where the position changing mechanisms 50K, 50C, 50M, and 50Y are not distinguished from one another, they may be referred to as the position changing mechanism 50.

The position changing mechanism 50 includes a ball screw 40, a linear guide 41, and the motor 42.

The ball screw 40 extends along the width direction B. The ball screw 40 is disposed at a position shifted in the conveyance direction A with respect to the head unit 12. The ball screw 40 may be disposed at a position overlapping the head unit 12 in plan view.

The head unit 12 is supported by the ball screw 40 and the linear guide 41. The motor 42 is provided at one end of the ball screw 40. The motor 42 may be disposed at a position close to the cleaning position 43 in plan view. The motor 42 drives the ball screw 40.

The linear guide 41 extends along the width direction B. The linear guide 41 extends from the liquid discharge position 10 to the cleaning position 43. The head unit 12 is movable along the linear guide 41. The linear guide 41 is disposed at a position shifted in the conveyance direction A with respect to the head unit 12. The linear guide 41 is disposed on an opposite side from the ball screw 40 with respect to the head unit 12. The linear guide 41 may be disposed at a position overlapping the head unit 12 in plan view. The linear guide 41 is an example of a guide. The linear guide 41 guides movement of the head unit 12 in the width direction B.

The controller 9 (see FIG. 2) can drive the ball screw 40 by controlling operation of the head unit mover 25 including the motor 42. The head unit 12 is guided by the ball screw 40 and the linear guide 41, and moves in the width direction B between the liquid discharge position 10 and the cleaning position 43. The motor 42 is provided for each of multiple the ball screws 40. The head units 12K 12C, 12M, and 12Y can independently move between the liquid discharge positions 10K, 10C, 10M, and 10Y and the cleaning positions 43K, 43C, 43M, and 43Y, respectively.

### Movement Control of Head Unit in Width Direction

The motor 42 may be a stepping motor that rotates by an amount corresponding to a designated number of pulses. In addition, the motor 42 may be a servomotor enabled to detect a rotational position of a rotation shaft of the motor 42 by an encoder and control the rotational position of the motor 42. By controlling the rotation direction and rotation speed of the motor 42 starting from a home position sensor that detects a position of a home position of the head unit 12, the image forming apparatus 100 can position the head unit 12 in the width direction B with high accuracy.

### Embodiment of Liquid Discharge Head Unit Adjustment Method

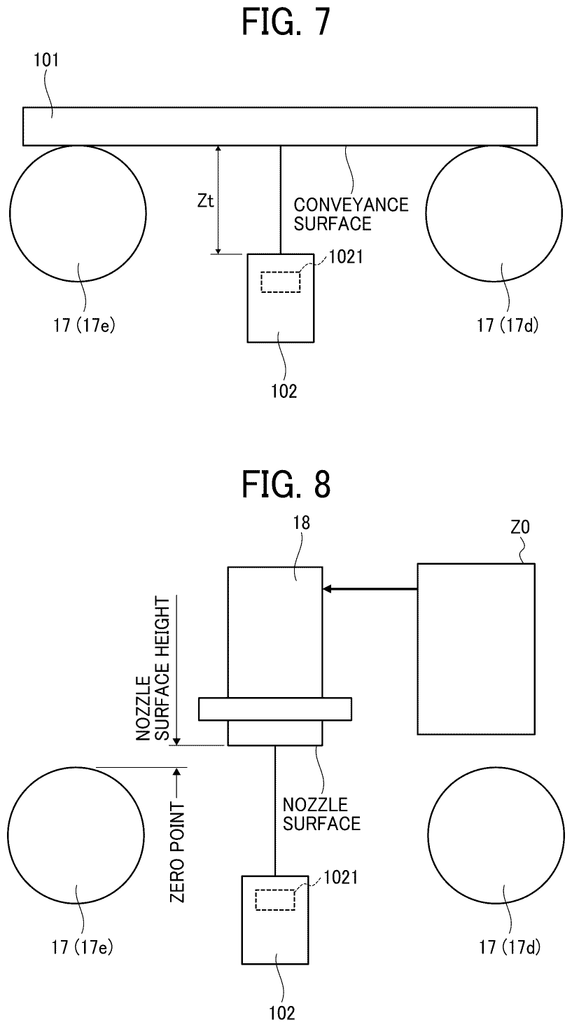

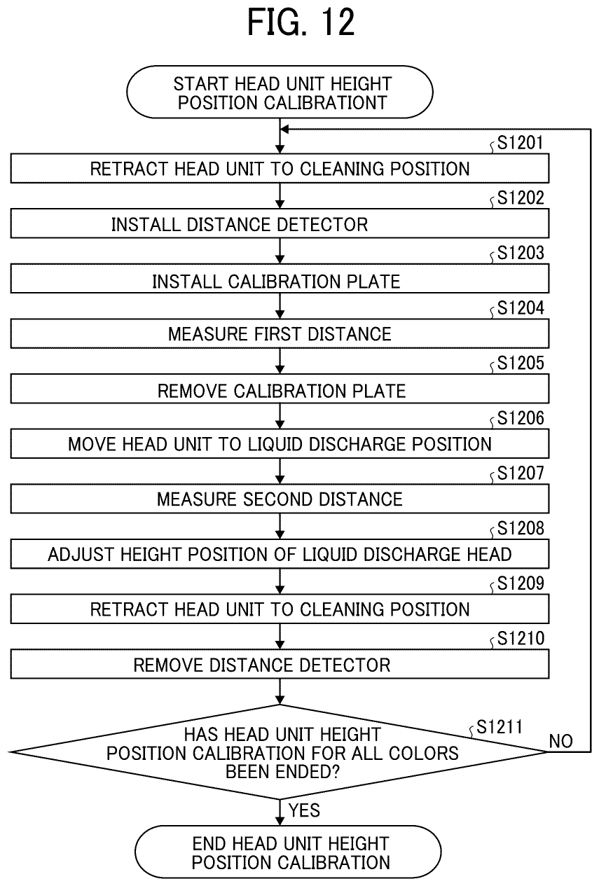

Next, an embodiment of a liquid discharge head unit adjustment method according to an embodiment of the present disclosure will be described with reference to a flowchart illustrated in FIG. 12, and FIGS. 7 and 8. A head unit height position calibration method according to an embodiment of the present disclosure includes a method for assembling and adjusting an initial position of the head unit 12 in the height direction, and a method for measuring and adjusting a nozzle surface height.

The flowchart illustrated in FIG. 12 exemplifies a procedure of the head unit height position calibration method.

Hereinafter, a description will be given on the basis of the flowchart illustrated in FIG. 12 while referring to FIG. 7 and the like. In the following description, a calibration method for the head unit 12K will be described, but the same procedure is basically applied to the other head units 12.

First, the head unit 12K is retracted to the cleaning position 43 (S1201). At this time, the sheet S has been removed.

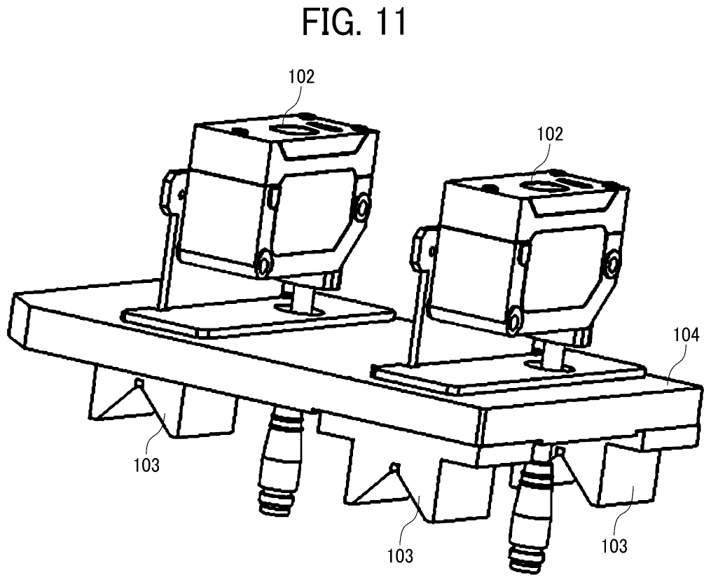

Subsequently, as illustrated in FIG. 7, a laser displacement meter 102 as a distance measurement unit is installed between the driven roller 17d on the upstream side and the driven roller 17e on the downstream side (S1202). The laser displacement meter 102 may be referred to as “a distance detector”. The laser displacement meter 102 is installed on support shafts 22 (see FIG. 10) described later. An installation position of the laser displacement meter 102 is a position corresponding to a position of the lifter Z0, and an installation direction is a direction in which a laser emission direction faces the conveyance surface. The distance measurement unit is not limited to a system using a laser, and an eddy current system, a capacitance system, or other systems can also be used. The laser displacement meter 102 includes a display unit 1021 that displays a measurement value. In the display unit 1021, a distance (measurement distance Zt) from a laser emission end of the laser displacement meter 102 to a measurement target object is displayed as a numerical value. The support shafts 22 supports the laser displacement meter 102 at the installation position. Thus, the support shafts 22 may be referred to simply as “a support”.

As illustrated in FIG. 7, a calibration plate 101 is installed on the conveyance surface of the driven roller 17d and the driven roller 17e so as to straddle a space between the driven roller 17d on the upstream side and the driven roller 17e on the downstream side (S1203). It is assumed that the calibration plate 101 as a conveyance surface calibration member includes a high-strength plate-like member with little distortion such as steel material, stainless steel, or aluminum alloy, and at least one surface is finished with high precision flatness. That is, the calibration plate 101 includes a material having strength such that a change (deflection) due to a weight of the calibration plate 101 is less than or equal to a resolution of measurement in the laser displacement meter 102 described later. Note that it is desirable that one surface (high-precision surface) of the calibration plate 101 is polished to have flatness less than or equal to 0.01 mm and surface roughness Ra less than or equal to 1.6. That is, the flatness of the calibration plate 101 is such that the deflection due to the weight of the calibration plate 101 generated on a surface on a side placed on the conveyance surface of the driven roller 17d on the upstream side and the driven roller 17e on the downstream side is less than or equal to the resolution of measurement by the laser displacement meter 102. As illustrated in FIG. 7, when the high-precision surface of the calibration plate 101 is temporarily placed on the conveyance roller 17, the high-precision surface coincides with the conveyance surface.

Subsequent to a conveyance surface calibration member setting process of step S1203, as a calibration measurement process, a distance detected by the laser displacement meter 102 to the high-precision surface of the calibration plate 101 is measured, and a measurement value of the distance is set as a “first distance”. The first distance is set as a zero point (S1204). As a result, the zero point of the laser displacement meter 102 is set (calibrated). Thereafter, the calibration plate 101 temporarily placed is removed (S1205).

Although it is conceivable to calibrate the distance measurement unit by using the sheet S, surface smoothness of the sheet S is not good, such as floating from the conveyance surface or generation of wrinkles in a part of the sheet S. Thus, by using the calibration plate 101, it is possible to solve a problem in the case of using the sheet S.

Subsequently, the head unit 12K is moved from the cleaning position 43 to the liquid discharge position 10, and a position of the nozzle surface of the liquid discharge head 18 is set to a position facing the laser displacement meter 102 (S1206). By step S1206, a state illustrated in FIG. 8 is obtained. Here, in step S1204, the laser displacement meter 102 has been adjusted with the conveyance surface as the zero point.

Subsequent to step S1206, as a liquid discharge head unit measurement process, a distance to the nozzle surface is measured by the laser displacement meter 102 in which the zero point is set, and a measurement value of the distance is displayed on the display unit 1021 (S1207). The measurement value is referred to as a “second distance”. The second distance corresponds to the “nozzle surface height”.

Subsequently, on the basis of the second distance, a height position of the liquid discharge head 18 is adjusted by the lifter Z0 (S1208). As an example, a case will be described where a design value of the nozzle surface height is 1.5 mm and the measurement value of the second distance displayed on the display unit 1021 is 1.35 mm. In this case, the lifter Z0 is operated so as to move the position of the liquid discharge head 18 upward by 0.15 mm. With this operation, the position of the liquid discharge head 18 is adjusted and secured on the basis of the second distance measured by the laser displacement meter 102. A process of adjusting the height position of each liquid discharge head 18 using the lifter Z0 is defined as a lifting and lowering process.

The position of the liquid discharge head 18 may also be adjusted and secured on the basis of a difference between the first distance and the second distance measured by the laser displacement meter 102. For example, the first distance and the second distance are measured by the laser displacement meter 102. The difference between the first distance and the second distance is calculated to obtain a gap between the nozzle surface and the conveyance surface, which is a lower surface of the calibration plate 101 facing the laser displacement meter 102 (distance detector). The lifter Z0 adjusts the position (height) of the liquid discharge head 18 according to the gap as the difference between the first distance and the second distance. As illustrated in FIG. 8, the gap is distance between the zero point (height of the conveyance surface) and a nozzle surface height that is a height of the nozzle surface of the liquid discharge head 18.

Subsequently, the motor 42 is driven to retract the head unit 12 to the cleaning position 43 (S1209). Subsequently, the laser displacement meter 102 is removed (S1210). If the processes from step S1201 to step S1210 have not been executed for the liquid discharge heads 18 of all colors (S1211: NO), the process returns to step S1201, and calibration is executed for the liquid discharge head 18 that has not been adjusted. If the calibration has been executed for the liquid discharge heads 18 of all the colors (S1211: YES), height position calibration of the liquid discharge head 18 is ended.

As described above, the calibration for determining the zero point by the first distance is performed. Thereafter, the distance (second distance) to the nozzle surface is measured by using the laser displacement meter 102 in a calibrated state. The nozzle surface height is adjusted by using the lifter Z0 on the basis of the second distance measured. As described above, by performing the adjustment and securing work on each liquid discharge head 18, it is possible to accurately assemble and adjust the initial positions in the height direction of all the liquid discharge heads 18.

Note that, in a calibration process for the height position of the liquid discharge head 18 described in the above flowchart, the distance measurement unit (laser displacement meter 102) is not permanently installed inside the image forming apparatus 100, and is installed at a predetermined position and direction when the calibration process is executed, and removed at the end. However, the distance measurement unit, for example, the laser displacement meter 102 may be provided inside the image forming apparatus 100.

In a case where the laser displacement meter 102 is included, in step S1202, instead of installing the laser displacement meter 102, it is sufficient that a moving mechanism for moving a position of the laser displacement meter 102 is operated to move the laser displacement meter 102 from a standby position to a predetermined measurement position. In step S1210, it is sufficient that the moving mechanism is operated to move the laser displacement meter 102 to the standby position. For example, the moving mechanism may move the laser displacement meter 102 along the support shaft 22 as the support between the standby position and the measurement position. The moving mechanism may be simply referred to as a “mover”.

When measurement is performed at multiple places, it is sufficient that the moving mechanism is operated each time to move the laser displacement meter 102 to a measurement position.

### Second Embodiment of Head Unit

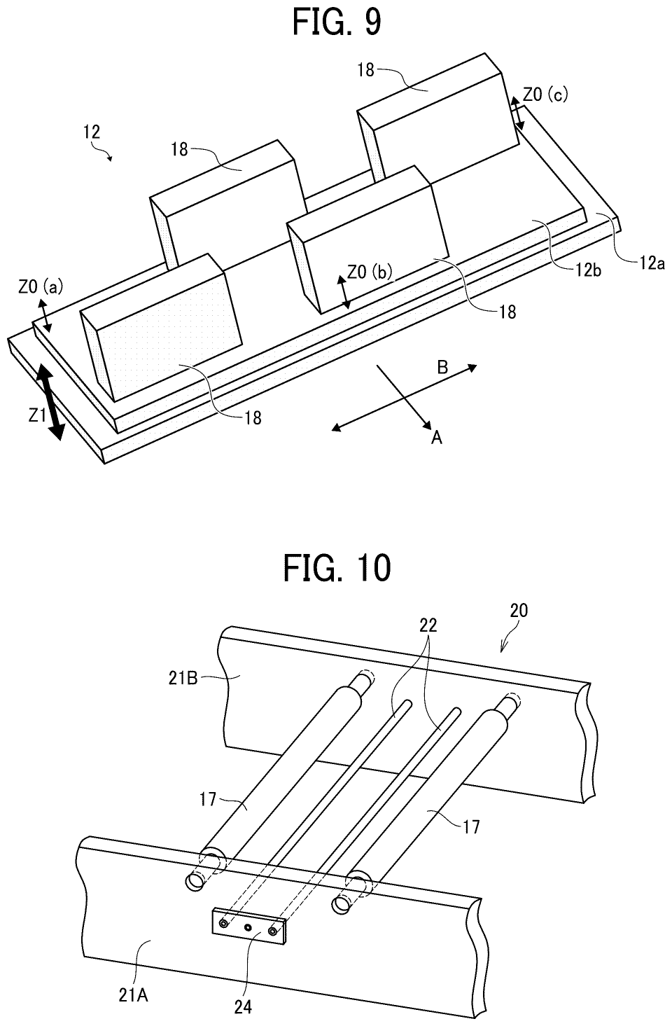

FIG. 9 is a diagram describing a perspective configuration of the head unit 12. The head unit 12 includes four liquid discharge heads 18, and a flat plate 12b and the base member 12a for supporting the four liquid discharge heads 18.

Since the flat plate 12b is manufactured with high accuracy and the four liquid discharge heads are secured thereto, the nozzle surfaces of the four liquid discharge heads are secured on the same surface. The flat plate 12b includes lifters Z0(a), Z0(b), and Z0(c) independently at three positions.

A manual mechanism such as a feed screw or an eccentric pin is generally employed as the lifter Z0, but an electric mechanism such as a servomotor or an actuator may be used. By adjusting the lifters independently provided at three positions, the four head units can be lifted and lowered collectively. This configuration can simplify adjustment work in a case where the number of head units to be mounted is large (for example, 10). At the time of assembling the image forming apparatus, the lifter Z0 is temporarily secured at an appropriate position. The method for the adjustment is as described above.

As described above, the head unit 12 also includes the lifter Z1 that lifts and lowers the entire head unit 12, and can keep the gap between the nozzle surface and the sheet S constant by lifting and lowering the head unit 12 even if the thickness of the sheet S differs.

Since the head unit 12 is held at both ends, the head unit 12 tends to be deflected due to a weight of the head unit 12. Thus, as illustrated in FIG. 9, the lifter Z0 may be provided at three positions at both ends and substantially the center of the head unit 12, and the laser displacement meter 102 may be installed at corresponding positions to perform measurement at three positions. Three laser displacement meters 102 may be installed and used to perform the measurement at the three positions once, or one laser displacement meter 102 may be used to perform the measurement three times separately.

### Support Portion for Laser Displacement Meter

FIG. 10 is a perspective view illustrating a support portion for the laser displacement meter 102 according to an embodiment of the present disclosure. As illustrated in FIG. 10, a pair of side plates 21A and 21B are roller support members that support both end sides (both ends or the vicinity thereof) of the conveyance rollers 17, and are disposed in parallel to each other at an interval. Each support shaft 22 supporting the laser displacement meter 102 is attached between the pair of side plates 21A and 21B. Each of the pair of side plates 21A and 21B is provided with a securing member 24 for securing the support shaft 22. That is, both end portions of the support shafts 22 are attached to the side plates 21A and 21B via the securing member 24. The support shafts 22 are provided for each of head units 12K, 12C, 12M, and 12Y at each positions facing the head units 12K, 12C, 12M, and 12Y in the discharge direction.

### Mounting Structure of Laser Displacement Meter

FIG. 11 is a perspective view illustrating a mounting structure of the laser displacement meter 102 according to an embodiment of the present disclosure. As illustrated in FIG. 11, a bracket 104 includes three V blocks 103 in a lower portion, and is enabled to be supported by the support shafts 22 (see FIG. 10) as an installation portion. The laser displacement meter 102 is slidably supported on the support shafts 22. That is, the laser displacement meter 102 is enabled to slide steplessly in the B direction described above and to be installed at a predetermined position. Two laser displacement meters 102 are provided on the bracket 104. Each of the laser displacement meters 102 is positioned so as to face the liquid discharge heads 18 on the upstream side and the downstream side in the conveyance direction (A direction) of the sheet S.

The image forming apparatus 100 according to an embodiment of the present disclosure described above can measure the height of any liquid discharge head 18 for accurately assembling and adjusting the initial position of the liquid discharge head 18 in the height direction.

Note that the image forming apparatus 100 can accurately assemble and adjust the initial position of the liquid discharge head 18 in the height direction by lifting and lowering the liquid discharge head 18 according to the distance between the calibration plate 101 and the liquid discharge head 18 in height measurement for the liquid discharge head 18.

The above configuration is an example, and for example, the bracket 104 may have a width as wide as a width of the sheet S, and a laser displacement meter may be installed at a necessary location.

In addition, the laser displacement meter may be installed on the image forming apparatus, but may be attached only when the initial position of the head unit in the height direction is assembled and adjusted. In general, assembly and adjustment of the initial position are necessary at the time of shipment from a factory or when the liquid discharge head is replaced in the market.

According to an embodiment of the present disclosure, it is possible to improve accuracy of a result of adhesion of liquid to be caused to adhere to a medium by the head unit.

The present disclosure is not limited to the specific embodiments described above, and numerous additional modifications and variations are possible in light of the teachings within the technical scope of the appended claims. It is therefore to be understood that the above embodiments of this patent specification may be practiced otherwise by those skilled in the art than as specifically described herein, and such modifications and variations are within the technical scope of the appended claims. Such embodiments and variations thereof are included in the scope and gist of the embodiments of the present disclosure and are included in the embodiments described in claims and the equivalent scope thereof.

The details of the present embodiments are, for example, as follows.

### Aspect 1

According to Aspect 1, a liquid discharge apparatus discharges liquid from a liquid discharge head unit to a conveyance object, and the liquid discharge apparatus includes: a pair of conveyance guides installed on an upstream side and a downstream side in a conveyance direction of the conveyance object with respect to the liquid discharge head unit; an installation portion on which a distance measurement unit is installed at a position facing the liquid discharge head unit in a discharge direction in which the liquid discharge head unit discharges the liquid; and a lifter that lifts and lowers the liquid discharge head unit according to a first distance to a conveyance surface calibration member measured by the distance measurement unit in a state where the conveyance surface calibration member is installed on the conveyance guides instead of the conveyance object, and a second distance to a nozzle surface of the liquid discharge head unit measured by the distance measurement unit in a state where the conveyance surface calibration member is not installed.

### Aspect 2

According to Aspect 2, a liquid discharge apparatus discharges liquid from a liquid discharge head unit to a conveyance object, and the liquid discharge apparatus includes:
a pair of conveyance guides installed on an upstream side and a downstream side in a conveyance direction of the conveyance object with respect to the liquid discharge head unit;
a distance measurement unit installed at a position facing the liquid discharge head unit in a discharge direction in which the liquid discharge head unit discharges the liquid; and
a lifter that lifts and lowers the liquid discharge head unit according to a first distance to a conveyance surface calibration member measured by the distance measurement unit in a state where the conveyance surface calibration member is installed on the conveyance guides instead of the conveyance object, and a second distance to the liquid discharge head unit measured by the distance measurement unit in a state where the conveyance surface calibration member is not installed.

### Aspect 3

According to Aspect 3, in the liquid discharge apparatus of Aspect 1 or Aspect 2, the conveyance surface calibration member is a plate-like member including a material having a strength to cause a change due to a weight of the conveyance surface calibration member to be less than or equal to a resolution of measurement by the distance measurement unit, and a deflection of a surface on a side placed on the conveyance guides due to the weight of the conveyance surface calibration member is less than or equal to the resolution of the measurement.

### Aspect 4

According to Aspect 4, in the liquid discharge apparatus of any one of Aspects 1 to 3, an installation position of the distance measurement unit is any of a position corresponding to a position of the lifter, both ends of the liquid discharge head unit, or a substantially center of the liquid discharge head unit.

### Aspect 5

According to Aspect 5, an image forming apparatus includes: a conveyor that conveys a conveyance object having a sheet-like shape; and an image former that forms an image on the conveyance object, in which the image former includes a liquid discharge head unit, and is the liquid discharge apparatus of any one of Aspects 1 to 4 in which the liquid discharge head unit discharges liquid onto a conveyance object to be conveyed.

### Aspect 6

According to Aspect 6, a liquid discharge head unit adjustment method is for adjusting a distance of a liquid discharge head unit to a conveyance object to be conveyed, and the liquid discharge head unit adjustment method includes:
a conveyance surface calibration member setting process of installing a conveyance surface calibration member instead of the conveyance object on a pair of conveyance guides installed on an upstream side and a downstream side in a conveyance direction of the conveyance object with respect to the liquid discharge head unit;
a calibration measurement process of measuring a distance to the conveyance surface calibration member by a distance measurement unit installed at a position facing the liquid discharge head unit;
a liquid discharge head unit measurement process of measuring a distance to a nozzle surface of the liquid discharge head unit in a state where the conveyance surface calibration member is removed; and
a lifting and lowering process of lifting and lowering the liquid discharge head unit by a lifter according to the distances to the conveyance surface calibration member and the liquid discharge head unit measured in the calibration measurement process and the liquid discharge head unit measurement process.

### Aspect 7

According to Aspect 7, a liquid discharge head unit adjustment method is for adjusting a distance of a liquid discharge head unit to a conveyance object to be conveyed, and the liquid discharge head unit adjustment method includes:
a conveyance surface calibration member setting process of installing a conveyance surface calibration member instead of the conveyance object on a pair of conveyance guides installed on an upstream side and a downstream side in a conveyance direction of the conveyance object with respect to the liquid discharge head unit;
an installation process of installing a distance measurement unit at a position facing the liquid discharge head unit;
a calibration measurement process of measuring a distance to the conveyance surface calibration member by the distance measurement unit installed;
a liquid discharge head unit measurement process of measuring a distance to a nozzle surface of the liquid discharge head unit in a state where the conveyance surface calibration member is removed; and
a lifting and lowering process of lifting and lowering the liquid discharge head unit by a lifter according to the distances to the conveyance surface calibration member and the liquid discharge head unit measured in the calibration measurement process and the liquid discharge head unit measurement process.

A liquid discharge apparatus includes a head having a nozzle surface having nozzles to discharge a liquid onto a medium in a discharge direction; a conveyor to convey the medium to the head along a conveyance surface in a conveyance direction, the conveyor including a pair of conveyance guides on an upstream side and a downstream side of the head in the conveyance direction; a support between the pair of conveyance guides in the conveyance direction, the support supportable a distance detector at a position facing the head in the discharge direction, and the distance detector to detect a first distance and a second distance; and a lifter to move the head in the discharge direction according to: a first distance from the distance detector to the conveyance surface of the conveyor; and a second distance from the distance detector to the nozzle surface of the head.

The liquid discharge apparatus further includes the distance detector supported by the support.

In the liquid discharge apparatus, the conveyor is placeable a plate on the conveyance surface, the plate having a strength in which a deflection of the plate by weight of the plate is equal to or smaller than a resolution of measurement by the distance detector.

In the liquid discharge apparatus, the distance detector is at a position corresponding to any one of: the lifter; both ends of the head; or a center of the head.

An image forming apparatus includes a head unit including multiple heads including the head of the liquid discharge apparatus, and the head unit discharges the liquid from the heads onto the medium to form an image on the medium.

A head adjustment method includes adjusting a distance of a head to a medium, in a discharge direction of the head, the medium to be conveyed by a pair of conveyance guides along a conveyance surface in a conveyance direction; installing a plate on the pair of conveyance guides on an upstream side and a downstream side of the head in the conveyance direction; measuring a first distance from a distance detector to the plate; removing the plate from on the pair of conveyance guides; measuring a second distance from the distance detector to a nozzle surface of the head; and moving the head in the discharge direction according to the first distance and the second distance.

The head adjustment method further includes installing the distance detector at a position facing the head.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A liquid discharge apparatus comprising:
a head having a nozzle surface having nozzles to discharge a liquid onto a medium in a discharge direction;
a conveyor to convey the medium to the head along a conveyance surface in a conveyance direction, the conveyor including a pair of conveyance guides on an upstream side and a downstream side of the head in the conveyance direction;
a support between the pair of conveyance guides in the conveyance direction,
the support supportable a distance detector at a position facing the head in the discharge direction, and
the distance detector to detect a first distance and a second distance; and
a lifter to move the head in the discharge direction according to:
the first distance from the distance detector to the conveyance surface of the conveyor; and
the second distance from the distance detector to the nozzle surface of the head.

2. The liquid discharge apparatus according to claim 1, further comprising the distance detector supported by the support.

3. The liquid discharge apparatus according to claim 1,
wherein the conveyor is placeable a plate on the conveyance surface,
the plate having a strength in which a deflection of the plate by weight of the plate is equal to or smaller than a resolution of measurement by the distance detector.

4. The liquid discharge apparatus according to claim 1,
wherein the distance detector is at a position corresponding to any one of:
the lifter;
both ends of the head; or
a center of the head.

5. An image forming apparatus comprising:
a head unit including multiple heads including the head of the liquid discharge apparatus according to claim 1, and
the head unit discharges the liquid from the heads onto the medium to form an image on the medium.

6. A head adjustment method comprising:
adjusting a distance of a head to a medium, in a discharge direction of the head, the medium to be conveyed by a pair of conveyance guides along a conveyance surface in a conveyance direction;
installing a plate on the pair of conveyance guides on an upstream side and a downstream side of the head in the conveyance direction;
measuring a first distance from a distance detector to the plate;
removing the plate from on the pair of conveyance guides;
measuring a second distance from the distance detector to a nozzle surface of the head; and
moving the head in the discharge direction according to the first distance and the second distance.

7. The head adjustment method according to claim 6, further comprising installing the distance detector at a position facing the head.
